(19) United States
(12) Patent Application Publication
(10) Pub. No.: US 2013/0242798 A1
(43) Pub. Date: Sep. 19, 2013

(54) APPARATUS FOR DUPLICATING ROUTER IN BUILDING AUTOMATIC CONTROL SYSTEM AND CONTROLLING METHOD THEREOF

(71) Applicants: Byung Hoon YOO, Anyang-si (KR); Kyung Jae Lee, Seoul (KR)

(72) Inventors: Byung Hoon YOO, Anyang-si (KR); Kyung Jae Lee, Seoul (KR)

(73) Assignee: NARA CONTROLS INC., Seoul (KR)

(21) Appl. No.: 13/418,832

(22) Filed: Mar. 13, 2012

(51) Int. Cl. H04L 12/28

(52) U.S. Cl. 370/254

(57) ABSTRACT

There is disclosed a network apparatus connecting BACnet/IP and BACnet/MSTP that are standard networks used in a building automatic control system such as equipments, electricity, lighting control of a building, more particularly, an apparatus for duplicating a router in a building automatic control system that can achieve stability of a network and reduce data transmission failure on a network and enable serial data transmission by controlling the other router to continuously perform a function of a router instead, when one of two routers installed thereof is stopped, and a controlling method thereof.

### FIELD

Embodiments of the invention may relate to a network apparatus, more particularly, to an apparatus for duplicating router in a building automatic control system that can secure stability of a network by controlling the other router to continuously perform a function of a router instead, when one of two routers installed thereof is stopped, and a controlling method thereof.

### BACKGROUND

Generally, a router connect communication between BACnet/IP network and BACnet/MSTP network in a building automatic control system for controlling equipments, electricity and lighting in a building, especially, a building automatic control system using BACnet.

According to a conventional building automatic control system, communication between the BACnet network and the BACnet/MSTP network is disconnected if there is an error in the router. Accordingly, it is impossible for a building manager to monitor and control a building. Also, it is impossible to integrally manage first devices connected to the BACnet/IP network and second devices connected to the BACnet/MSTP.

As a result, if there is an error in the router, a user has to substitute for the malfunctioned router or request a manufacturer for A/S, accordingly, the user fails to rapidly deal with the error.

### SUMMARY

Accordingly, the embodiments of the invention may be directed to an apparatus for duplicating a router in a building automatic control system and a controlling method thereof. An object of the invention is to provide an apparatus for duplicating a router in a building automatic control system that enables serial function performance by controlling the other one to perform a function of one of two routers, when one of two routers connected to a network is stopped, and a controlling method thereof.

Another object of the invention is to provide an apparatus for duplicating a router in a building automatic control system that can solves a concern of data loss in converting after switching and prevent overhead in communication by controlling the other one to perform a function of one of two routers, when one of two routers connected to a network is stopped, and a controlling method thereof.

To achieve these objects and other advantages and in accordance with the purpose of the embodiments, as embodied and broadly described herein, an apparatus for duplicating a router in a building automatic control system includes a first router module selectively connected to a BACnet/IP network via a first Ethernet line and to a BACnet/MSTP network via a first serial line (RS485); a second router module selectively connected to the BACnet/IP network via a second Ethernet line and to the BACnet/MSTP network via a second serial line (RS485); and a third serial line configured to connect the first router module and the second router module to each other, wherein one of the first and second router modules that communicates with the BACnet/IP network transmits a state-change signal representing a communication state thereof to the other router module.

When an error is generated in a communication state of the one of the first and second router modules that communicates with the BACnet/IP network, the other router module continuously may perform a function performed by the one of the first and second router modules.

When receiving the state-change signal with keeping a standby state, the other router module may transmit an acknowledge signal to the one of the first and second router modules.

The same IP address and MAC address may be set in the first and second router modules and the same serial network MAC address is set. The first router module and the second router module may simultaneously receive data via the first serial line and the second serial line, respectively, to enable data synchronization.

When the first router module and the second router module are operating simultaneously, a waiting time of the first router module may be set shorter than a waiting time of the second router module and the second router module may be in a standby state after the first router module is in a hot state.

When the other router module in a down state is restored while the one of the first and second router modules is operating in a hot state, the other router module may be in a standby state and receive data to enable data synchronization with the one of the first and second router modules.

The one of the first and second router modules that communicates with the BACnet/IP network may determine that an error is generated in a communication state thereof, when it fails to receive data from the BACnet/MSTP network or the BACnet/IP network within a preset time period.

In another aspect of the invention, a controlling method of an apparatus for duplicating a router in a building automatic control system including a first router module selectively connected to a BACnet/IP network via a first Ethernet line and to a BACnet/MSTP network via a first serial line (RS485); a second router module selectively connected to the BACnet/IP network via a second Ethernet line and to the BACnet/MSTP network via a second serial line (RS485); and a third serial line configured to connect the first router module and the second router module to each other, the controlling method includes an operating step of putting the first router module and the second router module into primary operation; and a transmitting step of controlling one of the first and second router modules that communicates the BACnet/IP network to transmit a state-change signal representing a communication state to the other router module via the third serial line, the transmitting step performed after the operating step.

The controlling method may further include a step of controlling the other router module to perform a function performed by the router module, when an error is generated in the communication state of the one of the first and second router modules that communicates with the BACnet/IP network.

The controlling method may further include a step of controlling the other router module to transmit an acknowledge signal to the one of the first and second router modules, when the other router module receives the state-change signal with keeping a standby state.

The controlling method may further include a step of controlling the first router module and the second router module to simultaneously receive data via the first serial line and the second serial line, respectively, with the same IP address and MAC address set to the first router module and the second router module and the same serial network MAC address.

In the operating step, the first router module may be operating in a hot state after a preset time period and the second router module may be operating in a standby state after the first router module is put into operation.

The controlling method may further include a step of controlling the other router module to be in a standby state and to perform data synchronization with the router module by receiving data via the BACnet/MSTP network, when the other router module in a down state is restored while the one of the first and second router modules is operating in a hot state.

The controlling method may further include a step of determining that an error is generated in a communication state of the one of the first and second router modules, when the one of the first and second router modules that communicates with the BACnet/IP network fails to receive data from the BACnet/MSTP network or the BACnet/IP network within a preset time period.

The apparatus for duplicating the router in the building automatic control system according to the embodiments of the invention may have following advantageous effects.

First of all, when one of two routers connected with the network is stopped, the other one may perform a function performed by the one and serial function performance may be enabled. Accordingly, data transmission failure on the network may be reduced as much as possible and serial data transmission may be enabled, only to achieve stability of the network.

Second, when one of the two routers connected to the network is stopped, the other one keeping the same data with one of the two routers may perform the function performed by one of the two routers. Accordingly, there is an effect of no concern about data loss in converting after switching and no overhead on the communication.

It is to be understood that both the foregoing general description and the following detailed description of the embodiments or arrangements are exemplary and explanatory and are intended to provide further explanation of the embodiments as claimed.

### BRIEF DESCRIPTION OF THE DRAWINGS

Arrangements and embodiments may be described in detail with reference to the following drawings in which like reference numerals refer to like elements and wherein:

FIG. 1 is a block diagram illustrating an apparatus for duplicating a router of a building automatic control system according to an embodiment of the invention;

FIG. 2 is a flow chart of data in the apparatus for duplicating the router of the building automatic control system; and

FIG. 3 is a flow chart illustrating a controlling method of the router duplicating in a building automatic control system.

### DETAILED DESCRIPTION

Reference may now be made in detail to specific embodiments, examples of which may be illustrated in the accompanying drawings. Wherever possible, same reference numbers may be used throughout the drawings to refer to the same or like parts. An apparatus for duplicating a router (hereinafter, a router duplicating apparatus) in a building automatic control system and a control method thereof.

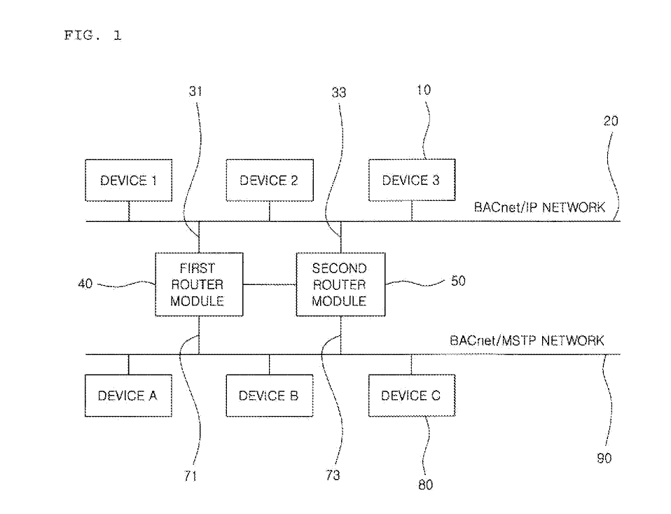

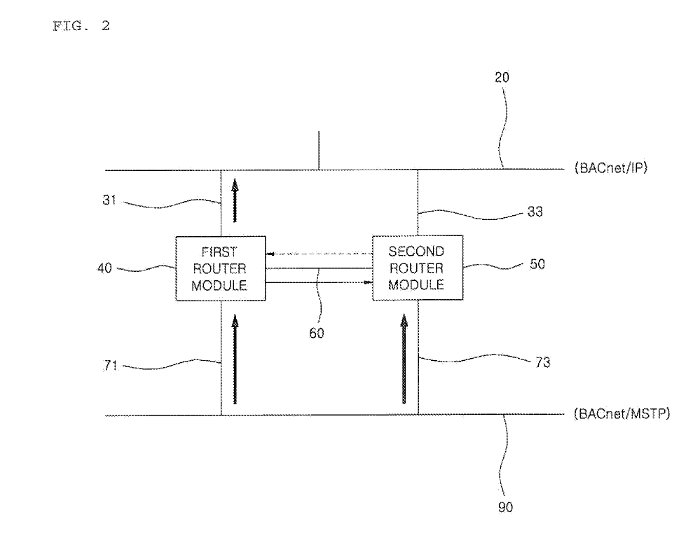

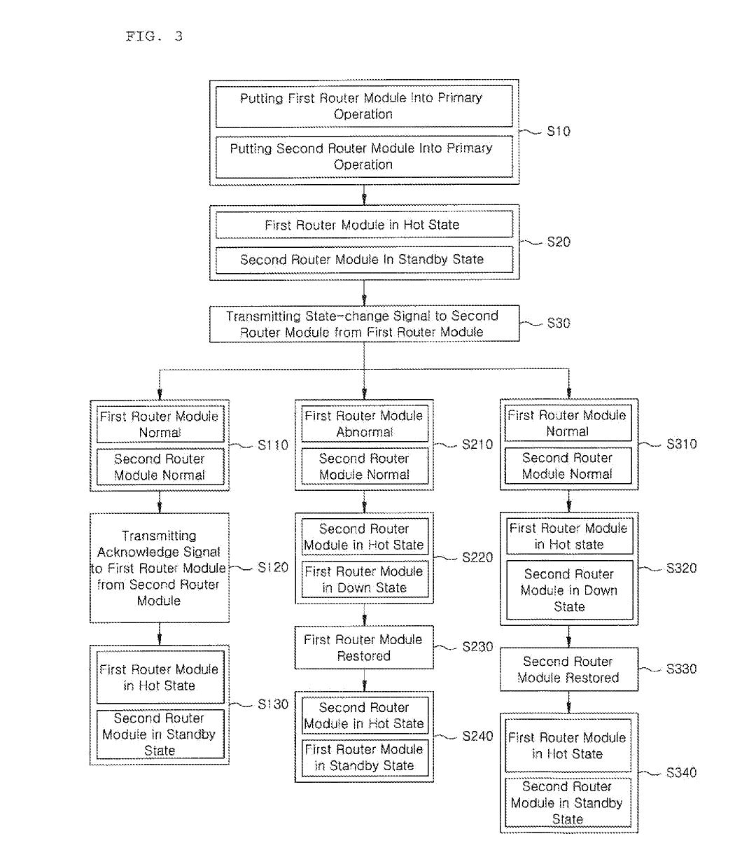

In reference to FIGS. 1 to 3, the router duplicating apparatus of the building automatic control system includes a first router module 40, a first Ethernet line 31 configured to connect the first router module 40 to a BACnet/IP network 20, a first serial line 71 configured to connect the first router module 40 to the BACnet/MSTP network 90, a second router module 50, a second Ethernet line 33 configured to selectively connect the second router module 50 to the BACnet/IP network 20, a second serial line 73 configured to connect the second router module 50 to the BACnet/MSTP network 90, and a third serial line 60 configured to connect the first router module 40 and the second router module 50 to each other.

When an error is generated in the communication of one of the first and second router modules 40 and 50 that communicates with the BACnet/IP network 20, the other one may continuously perform the function performed by the one of the first and second router modules.

In other words, only one of the first and second router modules 40 and 50 communicates with the BACnet/IP network 20. In contrast, the BACnet/MSTP network 90 can communicate with both of the first and second router modules 40 and 50.

In this instance, when one of the first and second router modules is in communication with the BACnet/IP network 20 and the BACnet/MSTP network 90 simultaneously, it is defined that the router module is in a hot state.

Also, when one of the router modules is in communication only with the BACnet/MSTP 90, not with the BACnet/IP network 20, it is defined that the router module is in a standby state.

When one of the router modules is in no communication with the BACnet/IP network 20 and the BACnet/MSTP network 90, it is defined that the router module is in a down state.

Also, when the two router modules are put into primary operation simultaneously, each of the router modules is in a ready state for waiting data. However, the waiting time of one of the router modules is set differential from that of the other one. The router module having a shorter waiting time set thereto may start earlier.

In the router duplicating apparatus according to this embodiment, the waiting time of the first router module 40 may be set shorter than the waiting time of the second router module 50. Specifically, the waiting time of the first router module 40 is set to be one second and the waiting time of the second router module 50 is set to be two seconds.

Accordingly, when the first router module 40 and the second router module 50 are put into primary operation simultaneously, one second passes from after the primary operation and the state of the first router module 40 is then changed into the hot state from the ready state. When one second re-passes from the time of the hot state changed from the ready state, in other words, when two seconds passes from the start time of the primary operation, the state of the second router module 50 is changed into the standby state from the ready state.

Meanwhile, the states of the router modules may be displayed on an LED module. For example, the corresponding router module is in the hot state, a corresponding LED module to the router module is on and off rapidly. When the corresponding router module is in the standby state, the corresponding LED module is on and off slowly.

Also, when the corresponding router module is in the down state, a corresponding LED to the router module is kept being off. When the corresponding router module is in the ready state, the corresponding LED module is kept being on.

The first serial line 71 and the second serial line 73 are used for RS485 serial communication. The third serial line 60 is used for RS232C serial communication. The first Ethernet line 31 and the second Ethernet line 33 are used for Ethernet communication.

A terminal of the BACnet/IP network 20 is connected with first devices 10 and the other terminal of the BACnet/IP network 20 is connected with the first and second router modules 40 and 50. Also, a terminal of the BACnet/MSTP network 90 is connected with the second devices 80 and the other terminal thereof is connected with the first and second router modules 40 and 50.

As a result, a single Ethernet port is physically divided into two channels. When there is an error in the communication line of one router module connected with one of the channels, the communication line connected is automatically converted into the other communication line of the other router module connected with the other channel.

At the same time, a single serial port connected with the first router module 40 and the second router module 50 is divided into two channels. When there is an error generated in the communication line connected with one channel, the communication line is automatically connected with the other channel to perform communication.

Meanwhile, the same IP addresses and MAC addresses are set to the first and second router modules 40 and 50, and the same serial network MAC addresses are set.

Accordingly, the first router module 40 and the second router module 50 receive data via the first serial line 71 and the second serial line 73, respectively, to perform synchronization of the data.

Also, one of the first and second router modules 40 and 50 which communicates with the BACnet/IP network 20 transmit a state-change signal representing a communication state thereof to the other router one via the third serial line 60.

When the other router module receives the state-change signal, with keeping the standby state, the other router module transmits an acknowledge signal to the one.

Specifically, an example of the state-change signal transmitted by the first router module 40 operating in the hot state will be described as follows.

When the first router module 40 is in a normal communication state, the first router module 40 transmits “0xx00” signal to the second router module 50.

Also, when there is a communication problem between the first router module 40 and the BACnet/MSTP network 90, the first router module 40 transmits “0xE1” signal to the second router module 40.

Also, when there is a communication problem between the first router module and the BACnet/IP network 20, the first router module transmits “0xE2” signal to the second router module 50.

When there is an error generated in a routing table, the first router module 40 transmits “0xE3” signal to the second router module 50.

When it is fails to receive the acknowledge signal from the second router module 50, the first router module 40 transmits “0xE4” signal to the second router module 50.

In this instance, the first router module 40 determines that there is a problem in the communication with the BACnet/IP network 20, when failing to receive data from the BACnet/IP network 20 within a preset time period.

Likewise, the first router module determines that there is a problem in the communication with the BACnet/MSTP network 90, when failing to receive data from the BACnet/MSTP network 90 within a preset time period.

Meanwhile, when the other one in the down state is restored while one of the first and second router modules 40 and 50 is operated in the hot state, the other router module may become in the standby state and it may receive data from the BACnet/MSTP network 90 to be data synchronized with the one of them.

An operation process of the router duplicating apparatus provided in the building automatic control system will be described as follows. In this instance, the waiting time of the first router module 40 is set to be one second and the waiting time of the second router module 50 is set to be two seconds, when the first and second router modules 40 and 50 are put into primary operation.

First of all, the first router module 40 and the second router module 50 are put into primary operation and the modules keeps the ready state before one second after the primary operation (S10).

Hence, when one second passes after the primary operation, the state of the first router module 40 is changed into the hot state from the ready state. In this instance, the first router module 40 may normally communicate with the BACnet/IP 20 and the BACnet/MSTP network 90.

After that, when one second passes after the first router module 40 becomes in the hot state, the operation state of the second router module 50 is changed into the standby state from the ready state. In this instance, the second router module 50 communicates not with the BACnet/IP network 20 but with the BACnet/MSTP network 90 (S20).

Hence, the first router module 40 transmits the state-change signal representing a communication state to the second router module 50 via the first serial line 60 (S30).

In this instance, when it receives the state-change signal while operating in the normal state, the second router module 50 transmits the acknowledge signal to the first router module 40 (S110, S120).

When the first router module 40 and the second router module 50 are operating normally, the first router module 40 is kept being in the hot state and the second router module 50 is kept being in the standby state (S130).

Also, when the first router module 40 is in the hot state and the second module 50 is in the standby state, data synchronization is performed between the first router module 40 and the second router module 50.

Specifically, the same IP addresses and MAC addresses are set to the first router module 40 and the second router module 50 and the same serial network MAC addresses are set. Accordingly, the first router module 40 and the second router module 50 simultaneously receives the same data from the BACnet/IP network 20 via the first serial line 71 and the second serial line 73, respectively, to perform data synchronization.

As a result, the second router module 50 may continuously perform the function performed by the first router module based on the synchronized data, even if an error is generated in the first router module 40.

Meanwhile, when it detects a communication error during the operation while the second router module 50 is normally kept being in the standby state, the first router module 40 transmits a state-change signal including error information to the second router module 50.

In this instance, the first router module 40 determines that there is an error in the communication state with the first router module 40, when it fails to receive data from the BACnet/IP network 20 or the BACnet/MSTP 90 within a preset time period (S210).

When it acknowledges that there is an error in the first router module 40, in other words, when it receives the state-change signal, the operation state of the second router module 50 is changed into the hot state from the standby state and the operation state of the first router module 40 is changed into the down state from the hot state. Accordingly, the second router module 50 may continuously perform the function performed by the first router module 40 (S220).

In this instance, the second router module 50 communicates with the BACnet/IP network 20 and it reports information about the error to a user. The error information may be displayed on the display module.

Meanwhile, when there is an error in the second router module 50 in the state of the first router module 40 operating normally, the second router module 50 fails to transmit the acknowledge signal to the first router module 40 (S310).

Accordingly, when failing to receive the acknowledge signal from the second router module 50, the first router module 40 acknowledges that an error is generated in the second router module 50 and it reports corresponding information about the error to the user. In this instance, the second router module 50 may be in the down state (S320).

Meanwhile, when an error is generated even in the second router module 50 after the first router module transmits the state-change signal including the error information about the communication error by detecting the error in the communication state during the operation, the second router module 50 fails to transmit the acknowledge signal to the first router module 40.

In this instance, when the standby stated router module out of the router modules, that is, the second router module 50 fails to receive the state-change signal of the first router module 40 or to transmit the acknowledge signal to the first router module 40, the operation state of the router module is changed, into the down state.

Accordingly, the second router module 50 is in the down state and the first router module 40 is kept being in the current state.

Meanwhile, when the other one in the down state is restored while one of the first and second router modules 40 and 50 is operating in the hot state, the other one is in the standby state (S230, S240, S330, and S340).

For example, when the second router module 50 is restored while the first router module 40 is operating in the hot state, the second router module 50 is set to be in the standby state (S330, S340).

In this instance, the second router module 50 receives data via the BACnet/MSTP network 90 and data synchronization is performed between the first router module 40 and the second router module 50.

Although embodiments have been described with reference to a number of illustrative embodiments thereof, it should be understood that numerous other modifications and embodiments can be devised by those skilled in the art that will fall within the spirit and scope of the principles of this disclosure.

What is claimed is:

1. An apparatus for duplicating a router in a building automatic control system comprising:
a first router module selectively connected to a BACnet/IP network via a first Ethernet line and to a BACnet/MSTP network via a first serial line (RS485);
a second router module selectively connected to the BACnet/IP network via a second Ethernet line and to the BACnet/MSTP network via a second serial line (RS485); and
a third serial line configured to connect the first router module and the second router module to each other,
wherein one of the first and second router modules that communicates with the BACnet/IP network transmits a state-change signal representing a communication state thereof to the other router module.

2. The apparatus according to claim 1, wherein when an error is generated in a communication state of the one of the first and second router modules that communicates with the BACnet/IP network, the other router module continuously performs a function performed by the one of the first and second router modules.

3. The apparatus according to claim 1, wherein when it receives the state-change signal, with keeping a standby state, the other router module transmits an acknowledge signal to the one of the first and second router modules.

4. The apparatus according to claim 1, wherein the same IP address and MAC address are set to the first and second router modules and the same serial network MAC address is set, and
the first router module and the second router module simultaneously receive data via the first serial line and the second serial line, respectively, to enable data synchronization.

5. The apparatus according to claim 1, wherein when the first router module and the second router module are operating simultaneously, a waiting time of the first router module is set shorter than a waiting time of the second router module, and the second router module is in a standby state after the first router module is in a hot state.

6. The apparatus according to claim 1, wherein when the other router module in a down state is restored while the one of the first and second router modules is operating in a hot state, the other router module is in a standby state and receives data to enable data synchronization with the one of the first and second router modules.

7. The apparatus according to claim 1, wherein the one of the first and second router modules that communicates with the BACnet/IP network determines that an error is generated in a communication state thereof, when failing to receive data from the BACnet/MSTP network or the BACnet/IP network within a preset time period.

8. A controlling method of an apparatus for duplicating a router in a building automatic control system comprising a first router module selectively connected to a BACnet/IP network via a first Ethernet line and to a BACnet/MSTP network via a first serial line (RS485); a second router module selectively connected to the BACnet/IP network via a second Ethernet line and to the BACnet/MSTP network via a second serial line (RS485); and a third serial line configured to connect the first router module and the second router module to each other, the controlling method comprising:
an operating step of putting the first router module and the second router module into primary operation; and
a transmitting step of controlling one of the first and second router modules that communicates with the BACnet/IP network to transmit a state-change signal representing a communication state thereof to the other router module via the third serial line, the transmitting step performed after the operating step.

9. The controlling method according to claim 8, further comprising:
a step of controlling the other router module to perform continuously a function performed by the one of the first and second router modules, when an error is generated in the communication state of the one of the first and second router modules that communicates with the BACnet/IP network.

10. The controlling method according to claim 8, further comprising:
a step of controlling the other router module to transmit an acknowledge signal to the one of the first and second router modules, when the other router module receives the state-change signal with keeping a standby state.

11. The controlling method according to claim 8, further comprising:
a step of controlling the first router module and the second router module to simultaneously receive data via the first serial line and the second serial line, respectively, with the same IP address and MAC address set to the first router module and the second router module and the same serial network MAC address.

12. The controlling method according to claim 8, wherein in the operating step, the first router module is operating in a hot state after a preset time period and the second router module is operating in a standby state after the first router module is put into operation.

13. The controlling method according to claim 8, further comprising:
a step of controlling the other router module to be in a standby state and to perform data synchronization with the one of the first and second router modules by receiving data via the BACnet/MSTP network, when the other router module in a down state is restored while the one of the first and second router modules is operating in a hot state.

14. The controlling method according to claim 8, further comprising:
a step of determining that an error is generated in a communication state of the one of the first and second router modules, when the one of the first and second router modules that communicates with the BACnet/IP network fails to receive data from the BACnet/MSTP network or the BACnet/IP network within a preset time period.
